(19) United States
(12) Patent Application Publication
(10) Pub. No.: US 2025/0170740 A1
(43) Pub. Date: May 29, 2025

(54) KNIFE BLADE GUIDE AND METHOD

(71) Applicant: Ian Wilson, Glastonbury, CT (US)

(72) Inventor: Ian Wilson, Glastonbury, CT (US)

(21) Appl. No.: 18/835,730

(22) PCT Filed: Jun. 7, 2023
(86) PCT No.: PCT/US2023/068025

§ 371 Date: Aug. 4, 2024

Related U.S. Application Data
(60) Provisional application No. 63/479,257, filed on Jan. 10, 2023.

(51) Int. Cl. B26B 29/02; B26B 1/08

(52) U.S. Cl. CPC B26B 29/02; B26B 1/08

(57) ABSTRACT

A knife guide is disclosed which may include a hollow main body and a corner guide positioned on a front end of the hollow main body. The corner guide can have a right guide arm projecting from the front end, a left guide arm projecting from the front end, a blade slot positioned between the right guide arm and the left guide arm and wherein the right guide arm and the left guide arm are positioned at a predetermined angle apart from each other.

### CROSS REFERENCE TO RELATED APPLICATIONS

This application claims the benefit of U.S. Provisional Patent Application Ser. No. 63/479,257 having a filing date of 10 Jan. 2023. The disclosure of the application above is incorporated herein by reference in their entirety.

### BACKGROUND

Utility knives and box cutters are well known in the industry. It is a problem with such prior art devices in the “flattening” or breaking down of cardboard cartons to keep the blade of the knife engaged along a corner of the cardboard box. In addition, the prior art has no depth guidance capacity when opening taped boxes as the utility knife blades extend an inch or more from their blade slots allowing potential damage to the packaged goods. The deleterious effects of such knives of the prior art include irregular cuts and possible safety issues.

What is needed is a knife and knife accessory to resolve the problems of the prior art.

### SUMMARY

In one general aspect, a knife blade guide may include a hollow main body. The knife blade guide may also include a corner guide positioned on a front end of the hollow main body having a right guide arm projecting from the front end, a left guide arm projecting from the front end, a blade slot positioned between the right guide arm and the left guide arm, and where the right guide arm and the left guide arm are positioned at a predetermined angle apart from each other.

Implementations may include one or more of the following features. The knife blade guide where the hollow main body is configured to fit over a housing of an utility knife at a cutting end of the utility knife. The knife blade guide where the blade slot is configured to accommodate a cutting blade of the utility knife. The knife blade guide where the blade slot is configured to be positioned proximate a corner of a container and the right guide arm and the left guide arm are configured to be positioned against a respective side of the container. The knife blade guide where the corner guide is an outside corner guide having the right guide arm and the left guide arm project in a forwardly direction from the hollow main body, and the blade slot is any of a rectangular slot and an ovoid slot. The knife blade guide where the outside corner guide is configured to be placed on an outside portion of the corner of the container and the right guide arm and the left guide arm are configured to be positioned against an outside surface of the respective side of the container. The knife blade guide where the blade slot is configured to be positioned proximate an outside surface of the corner of the container. The knife blade guide where the outside corner guide is configured to guide the utility knife along the outside surface of the corner of the container and the cutting blade is configured to cut the corner of the container. The knife blade guide where the predetermined angle is an outside guide angle and is chosen to match an outside angle of the corner of the container. The knife blade guide where the outside guide angle may include an approximate 90 degree angle between the right guide arm and the left guide arm. The knife blade guide where the right guide arm may include a planar portion and a curved tip positioned on a bottom portion of the planar portion and the left guide arm may include a planar portion and a curved tip positioned on a bottom portion of the planar portion. The knife blade guide may include a strike plate positioned between the right guide arm and the left guide arm where the blade slot is positioned within the strike plate. The knife blade guide may include a scalloped region positioned between the right guide arm and the left guide arm where the blade slot is positioned within the scalloped region. The knife blade guide where the corner guide is an inside corner guide having the right guide arm and the left guide arm project in a rearwardly direction from the blade slot. The knife blade guide where the inside corner guide is configured to be placed on an inside portion of the corner of the container and the right guide arm and the left guide arm are configured to be positioned against an inside surface of the respective side of the container. The knife blade guide where the blade slot is configured to be placed proximate an inside surface of the corner of the container. The knife blade guide where the inside corner guide is configured to guide the utility knife along the inside surface of the corner of the container and the cutting blade is configured to cut the corner of the container. The knife blade guide where the predetermined angle is an inside guide angle and is chosen to match an inside angle of the corner of the container. The knife blade guide where the inside guide angle may include an approximate 270 degree angle between the right guide arm and the left guide arm. The knife blade guide further where the hollow main body may include a housing of an utility knife at a cutting end. The knife blade guide where the blade slot is configured to accommodate a cutting blade of the utility knife. The knife blade guide where the blade slot is configured to be positioned proximate a corner of a container and the right guide arm and the left guide arm are configured to be positioned against a respective side of the container. The knife blade guide where the corner guide is an outside corner guide having the right guide arm and the left guide arm project in a forwardly direction from the blade slot, and the blade slot is any of a rectangular slot and an ovoid slot. The knife blade guide where the outside corner guide is configured to be placed on an outside portion of the corner of the container and the right guide arm and the left guide arm are configured to be positioned against an outside surface of the respective side of the container. The knife blade guide where the blade slot is configured to be positioned proximate an outside surface of the corner of the container. The knife blade guide where the outside corner guide is configured to guide the utility knife along the outside surface of the corner of the container and the cutting blade is configured to cut the corner of the container. The knife blade guide where the predetermined angle is an outside guide angle and is chosen to match an outside angle of the corner of the container. The knife blade guide where the outside guide angle may include an approximate 90 degree angle between the right guide arm and the left guide arm. The knife blade guide where the corner guide is an inside corner guide having the right guide arm and the left guide arm project in a rearwardly direction from the blade slot, and a vertex of the predetermined angle is positioned at a point beyond the blade slot. The knife blade guide where the inside corner guide is configured to be placed on an inside portion of the corner of the container and the right guide arm and the left guide arm are configured to be positioned against an inside surface of the respective side of the container. The knife blade guide where the blade slot is configured to be positioned proximate an inside surface of the corner of the container. The knife blade guide where the inside corner guide is configured to guide the utility knife along the inside surface of the corner of the container and the cutting blade is configured to cut the corner of the container. The knife blade guide where the predetermined angle is an inside guide angle and is chosen to match an inside angle of the corner of the container. The knife blade guide where the inside angle may include an approximate 270 degree angle between the right guide arm and the left guide arm. The knife blade guide where the housing of the utility knife further may include a first cutting end and a second cutting end and an inside corner guide positioned at the first cutting end and an outside corner guide positioned at the second cutting end.

### BRIEF DESCRIPTION OF THE DRAWINGS

FIG. 1 is a side view of a utility knife of the prior art;

FIG. 2 is a side view of an outside corner guide in accordance with current disclosure;

FIG. 3 is a front perspective view of an outside corner guide in accordance with current disclosure;

FIG. 4 is a rear perspective view of an outside corner guide in accordance with current disclosure;

FIG. 5 is a top perspective view of an outside corner guide in accordance with current disclosure;

FIG. 6 is a bottom perspective view of an outside corner guide in accordance with current disclosure;

FIG. 7 is a side perspective view of an outside corner guide attached to a utility knife in accordance with current disclosure;

FIG. 8 is a side view of an inside corner guide in accordance with current disclosure;

FIG. 9 is a front perspective view of an inside corner guide in accordance with current disclosure;

FIG. 10 is a rear perspective view of an inside corner guide in accordance with current disclosure;

FIG. 11 is a top perspective view of an inside corner guide in accordance with current disclosure;

FIG. 12 is a bottom perspective view of an inside corner guide in accordance with current disclosure;

FIG. 13 is a side perspective view of an inside corner guide attached to a utility knife in accordance with current disclosure;

FIG. 14 is a front perspective view of a container of the prior art;

FIG. 15 is a top view of an outside corner guide set against a container corner in accordance with current disclosure;

FIG. 16 is a top view of an inside corner guide set against a container corner in accordance with current disclosure;

FIG. 17 is a side perspective view of a double ended box cutter guide in accordance with current disclosure;

FIG. 18 is a side perspective view of a double ended box cutter guide having integral inside corner guide and integral outside corner guide in accordance with current disclosure;

FIG. 19 is a top view of a double ended box cutter guide having integral inside corner guide and integral outside corner guide in accordance with current disclosure;

FIG. 20 is a left side view of an outside corner guide in accordance with current disclosure;

FIG. 21 is a front perspective view of an outside corner guide in accordance with current disclosure;

FIG. 22 is a rear perspective view of an outside corner guide in accordance with current disclosure;

FIG. 23 is a top perspective view of an outside corner guide in accordance with current disclosure;

FIG. 24 is a bottom perspective view of an outside corner guide in accordance with current disclosure;

FIG. 25 is a front perspective view of an outside corner guide in accordance with current disclosure; and

FIG. 26 is a bottom perspective view of an outside corner guide in accordance with current disclosure.

### DETAILED DESCRIPTION

The current disclosure is directed at implementations of devices to aid in the opening and breaking down of cuttable containers and includes knives, accessories for knives and methods for their use.

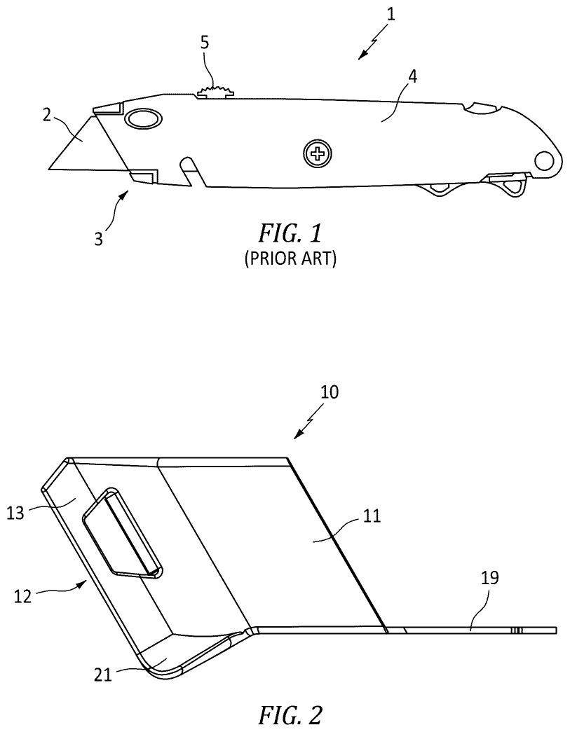

Referring to FIG. 1, there is shown a utility knife 1 of the prior art. Utility knife 1 is a single ended knife with cutting blade 2 projecting from a cutting end 3 of housing 4. In the embodiment shown, utility knife 1 cutting blade 2 is retractable within housing 4 by manipulating slide button 5 and it is shown in the extended position for cutting. Utility knife 1 of the prior art is manipulated unguided by a user by maneuvering housing 4 in order to perform a cutting operation.

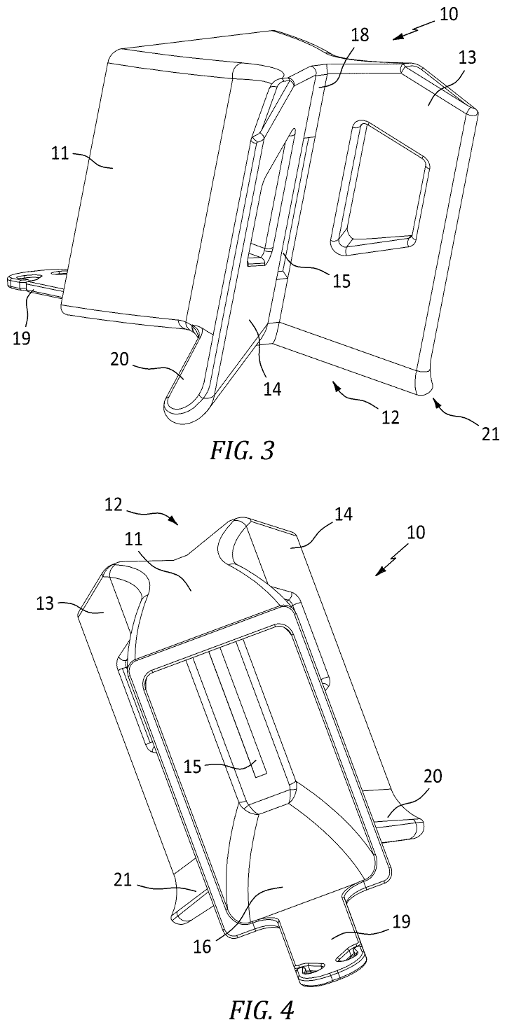

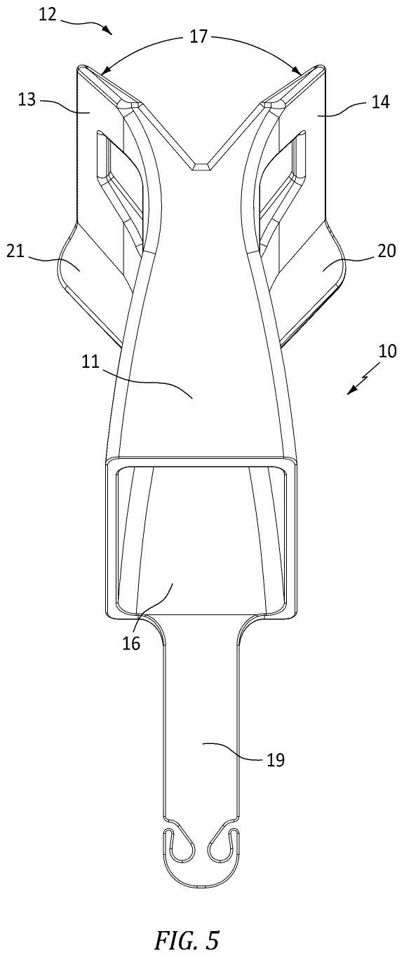

Referring next to FIGS. 2-6, there is shown outside corner guide 10 which includes hollow main body 11 and outside guide 12 positioned on a front end of the main body and is configured to guide a knife blade as will be disclosed in more detail herein after. Outside guide 12 is comprised of left arm 13, right arm 14 and blade slot 15, comprising a rectangular slot, positioned in a middle portion of strike plate 18. Left arm 13 and right arm 14 are planar surfaces wherein the planar portions are projecting in a forwardly direction from strike plate 18 and away from main body 11 and are positioned at a predetermined outside guide angle 17 (FIG. 5) to each other wherein the vertex of outside guide angle 17 is positioned within blade slot 15. Left arm 13 includes curved tip 20 positioned on a bottom thereof and curves backwards toward main body 11. Similarly, right arm 14 includes curved tip 21 positioned on a bottom thereof and curves backwards toward main body 11. Curved tip 20 and curve tip 21 facilitate the gliding action of outside guide while in operation by helping the guide arms to float onto and over surface irregularities. In the implementation shown, outside guide angle 17 is approximately 90 degrees and is configured to accommodate an outside corner of a cuttable container, such as cardboard, as will be disclosed in more detail herein after. In some implementations, outside guide angle 17 can include any angle that approximates the angle of the container to be cut and further includes angles slightly less and slightly more than the angle of the container to be cut. Main body 11 is comprised of a hollow member forming a knife cavity 16 with blade slot 15 positioned on a front portion thereof. It should be further appreciated by those skilled in the art that the main body 11 can be comprised of a conformable material such as rubber or a rigid plastic or other suitable material to provide a snug (or interference) fit around the cutting end of a utility knife (cutting end 3 in FIG. 1). Outside guide 12 can be comprised of the same material as main body 11 or a different material or can be comprised of a combination of materials. For example, left arm 13 and right arm 14 can be comprised of a material and/or include a contact surface design having a low coefficient of friction configured to slide along the surface of a cardboard container during use. An example of contact surface geometry fashioned to achieve a lower coefficient of friction would be slightly-raised fins (not shown) on the planar surfaces of left arm 13 and right arm 14 oriented in the cutting direction. It should be noted that outside corner guide 10 further includes attachment tang 19 positioned on a bottom portion for attachment to a utility knife. As will be described in more detail herein after, a rubber band (not shown) can be engaged within a first slot within attachment tang 19 and threaded through key chain hole 6 (FIG. 1) and engaged within the second slot on the attachment tang to hold outside corner guide 10 removably attached to the utility knife 1 (FIG. 1). It should be appreciated that other implementations disclosed having an optional attachment tang can similarly be removably attached to the utility knife.

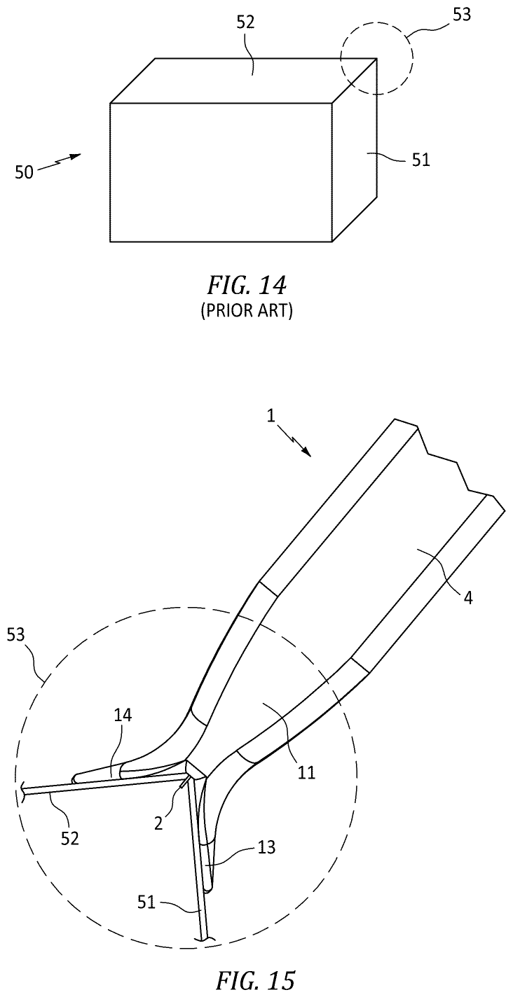

Referring now to FIG. 7, with reference back to the previous figures, there is shown outside corner guide 10 positioned on body 4 of utility knife 1 of FIG. 1. Cutting blade 2 is shown in the extended position within blade slot 15 and projecting between left arm 13 and right arm 14 of outside guide 12. In FIG. 14, there is shown a typical container 50 of the prior art with right side 51 and backside 52 forming corner detail 53 (as viewed from corner detail 53 and in FIG. 15). Container 50 can comprise any material capable of being sliced with a utility knife including cardboard, paperboard, plastics and other materials. The operation of outside corner guide 10 attached to utility knife 1 can be seen with reference to FIG. 15. In operation, outside corner guide 10 is configured to guide a knife blade wherein a user can position cutting blade 2 of utility knife 1 against an outside portion of an outside corner 53 of a cardboard container and pierce the container with the blade. Alternatively, the user can start the cut at the open top of container 50. In so doing, left arm 13 can be positioned against an outside surface of right side 51 and right arm 14 can be positioned against an outside surface of backside 52 of which are the respective sides of the container 50 that form the outside corner 53. Strike plate 18 is urged against the outside corner 53. The user can then translate utility knife 1 along the corner using outside guide 12 to accurately maintain cutting blade 2 in the vertex of the outside angle of outside corner 53 of the cardboard container 50. It should be appreciated by those skilled in the art that accurately maintaining cutting blade 2 in the vertex of the outside corner 53 of the cardboard container 50 enables a user to efficiently make clean and accurate cuts while cutting open or breaking down cuttable containers along a corner or edge seam from the outside of the container for efficient processing and cutting action resulting in tidy, rectangular cut panels.

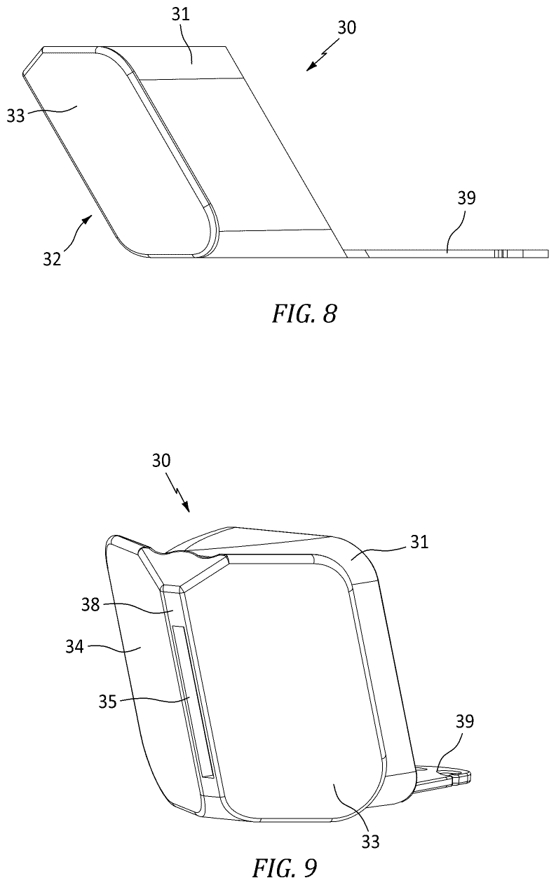

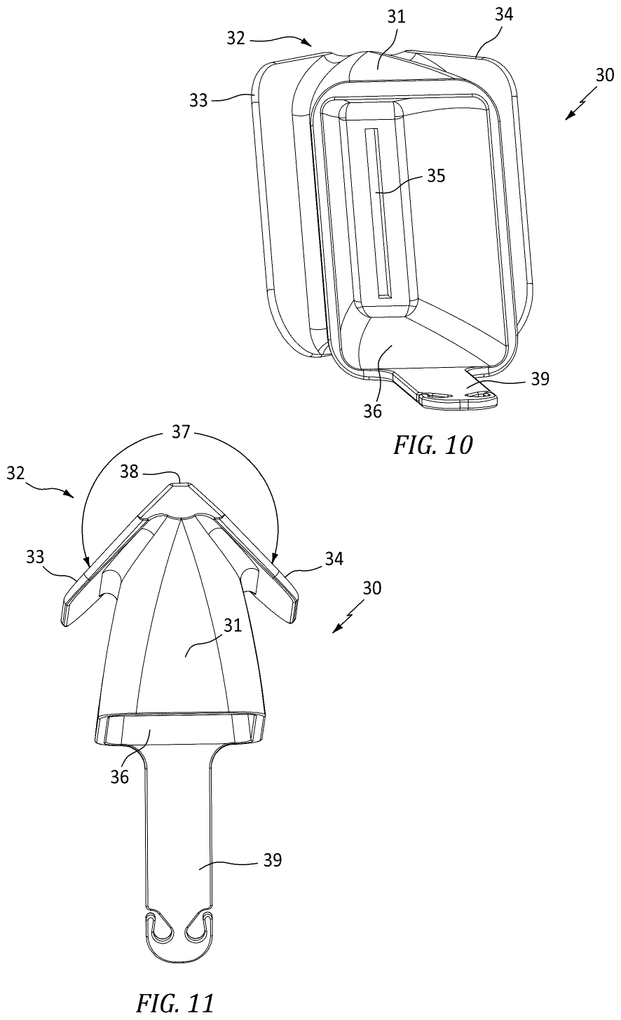

Another implementation of the current disclosure is shown with reference to FIGS. 8-12, there is shown inside corner guide 30 which includes a hollow main body 31 and inside guide 32 positioned on a front end of the main body which is configured to guide a knife blade as will be disclosed in more detail hereinafter. Inside guide 32 is comprised of left arm 33, right arm 34 and blade slot 35 comprising a rectangular slot positioned in a middle portion of strike plate 38. Right arm 33 and left arm 34 are planar portions projecting in a rearwardly direction from strike plate 38 toward main body 31 and are positioned at inside guide angle 37 (FIG. 11) wherein the vertex of inside guide angle 37 is positioned at a point beyond blade slot 35. In the implementation shown, inside guide angle 37 is approximately 270 degrees and is configured to accommodate an inside corner of a cardboard container as will be disclosed in more detail herein after. In some implementations, inside guide angle 37 can include any angle that approximates the angle of the container to be cut and further includes angles slightly less and slightly more than the angle of the container to be cut. Main body 31 is comprised of a hollow member forming a knife cavity 36 with blade slot 35 positioned on a front portion thereof. It should be further appreciated by those skilled in the art that main body 31 can be comprised of a conformable material such as rubber or a rigid plastic or other suitable material to provide a snug (or interference) fit around the cutting end of a utility knife (cutting end 3 in FIG. 1). Inside guide 32 can be comprised of the same material as main body 31 or a different material or can be comprised of a combination of materials. For example, left arm 33 and right arm 34 can be comprised of a material having a low coefficient of friction configured to slide along the surface of a cardboard container during use. It is contemplated by the present disclosure that left arm 33 and right arm 34 can include other features such as grooves or fins (not shown) to lessen the friction between the arms and the surface of the container to be cut. It should be noted that inside corner guide 30 further includes attachment tang 39 positioned on a bottom portion for attachment to a utility knife.

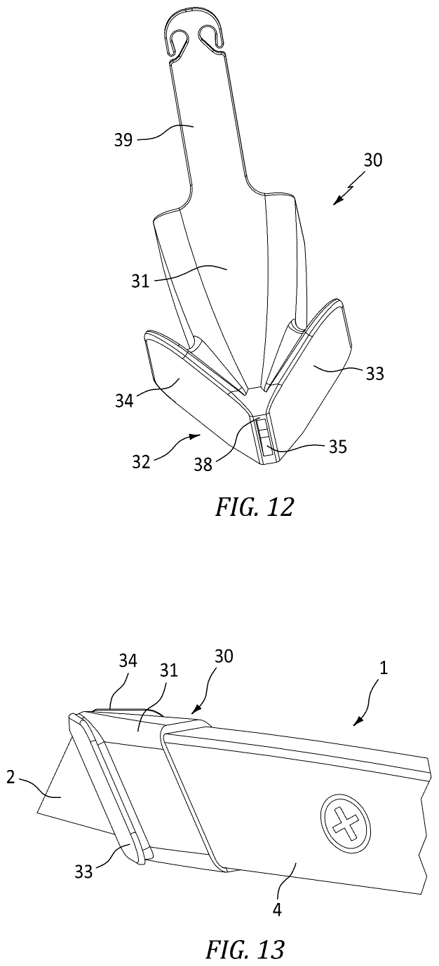

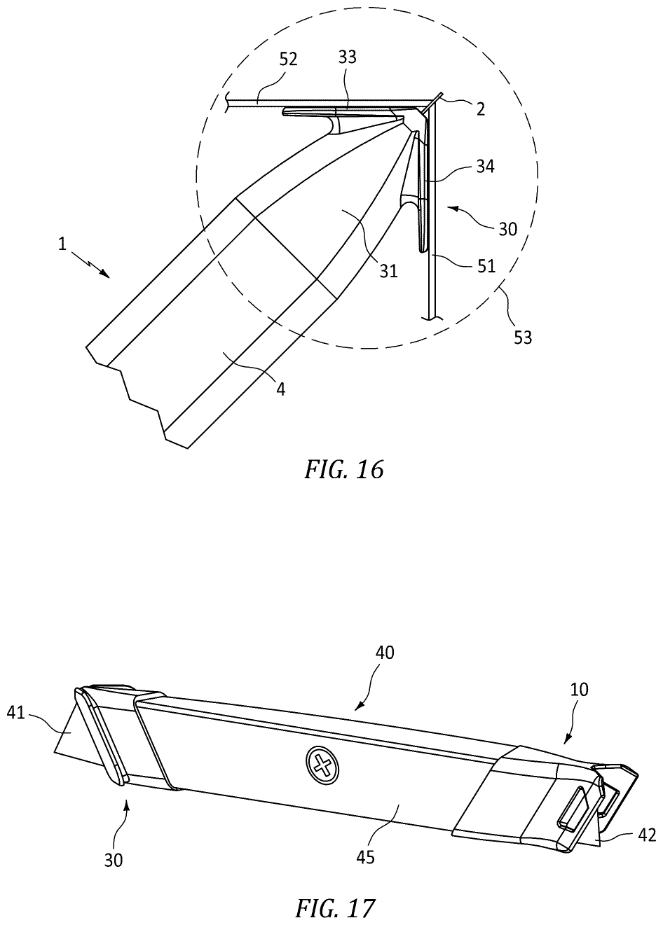

Referring now to FIG. 13, with reference back to the previous figures, there is shown inside corner guide 30 positioned on body 4 of utility knife 1 of FIG. 1. Cutting blade 2 is shown in the extended position within blade slot 35 and projecting between left arm 33 and right arm 34 of inside guide 32 (FIG. 12). The operation of inside corner guide 30 attached to utility knife 1 can be seen with reference to FIG. 16. In operation a user can position cutting blade 2 of utility knife 1 against an inside portion of an inside corner 53 of a cardboard container and pierce the container with the blade. Alternatively, the user can start the cut at the open top of container 50. In so doing, left arm 33 can be positioned against an inside surface of right side 51 and right arm 34 can be positioned against an inside surface of backside 52 of which are the respective sides of the container 50 that form the inside corner 53. Strike plate 38 is urged against the outside corner 53. The user can then translate utility knife 1 along the corner using inside guide 32 to accurately maintain cutting blade 2 in the vertex of the inside angle of corner 53 of the cardboard container 50. It should be appreciated by those skilled in the art that accurately maintaining cutting blade 2 in the vertex of the outside corner 53 of the cardboard container 50 enables a user to make clean and accurate cuts while breaking down cardboard containers from the inside of the container.

Another implementation of the current disclosure can be seen with reference to FIG. 17 where there is shown a double ended box cutter 40 comprised of a double ended utility knife 45 which includes a first cutting blade 41 on a left end and a second cutting blade 42 on a right end. In this particular implementation inside corner guide 30 is attached to the left hand end of double ended utility knife 45 with cutting blade 41 positioned in knife slot 35 and outside corner guide 10 attached to the right hand end of the double ended utility knife with cutting blade 42 positioned within blade slot 15. It should be apparent to those skilled in the art that double ended box cutter 40 would advantageously provide a user with the benefit of being able to accurately and safely slit the corners of cardboard cartons on both the inside corners and the outside corners with a single tool.

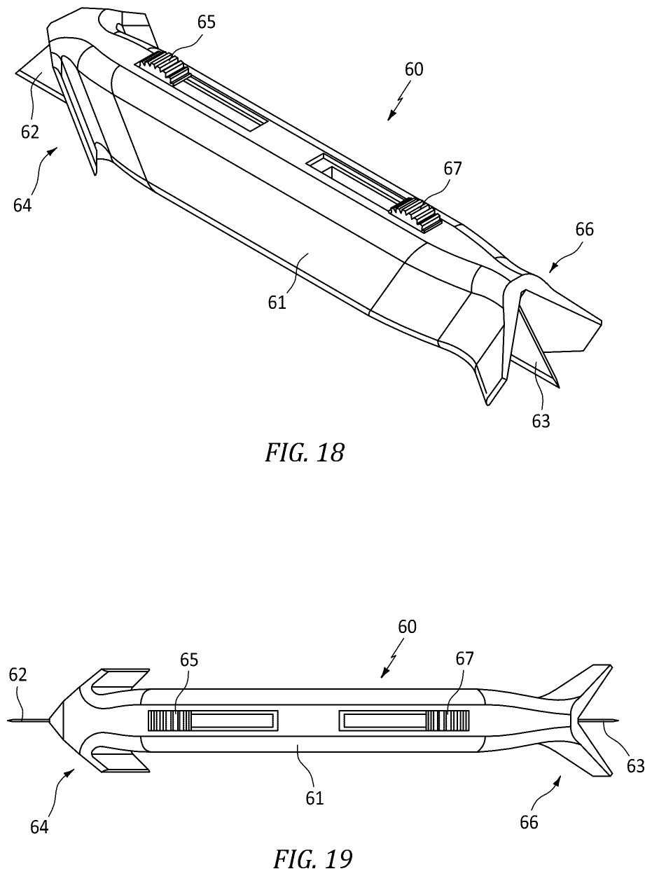

Another implementation of the current disclosure can be seen with reference to FIGS. 18-19 where there is shown a double ended box cutter 60 comprised of a hollow body 61 which includes a first cutting blade 62 on a left end and a second cutting blade 63 on a right end. In this particular implementation inside corner guide 64 is positioned on the left hand end of hollow body 61. It should be appreciated by those skilled in the art that inside corner guide 64 is integral to double ended box cutter 60 and includes the features of inside corner guide 30 (FIGS. 8-13) with cutting blade 62 positioned in a knife slot. Cutting blade 62 is shown in the extended position and is actuated between the extended position and a retracted position by manipulation of slide button 65. Double ended box cutter 60 further includes outside corner guide 66 positioned on the right hand end of hollow body 61. It should be appreciated by those skilled in the art that outside corner guide 66 is integral to double ended box cutter 60 and includes the features of outside corner guide 10 (FIGS. 2-7) with cutting blade 63 positioned in a knife slot. Cutting blade 63 is shown in the extended position and is actuated between the extended position and a retracted position by manipulation of slide button 67. It should be apparent to those skilled in the art that double ended box cutter 60 would advantageously provide a user with the benefit of being able to accurately and safely slit the corners of cardboard cartons on both the inside corners and the outside corners with a single tool. It should further be apparent to those skilled in the art that implementations of the present disclosure include those that are single ended box cutters having either an inside corner guide 64 or an outside corner guide 66.

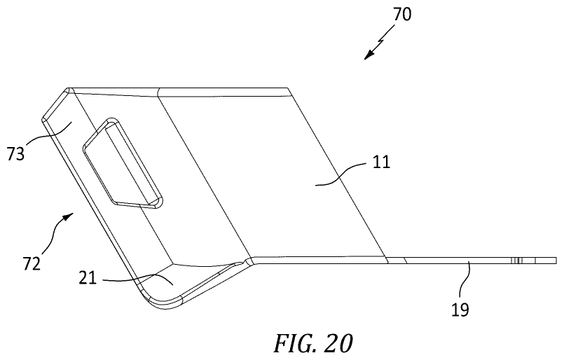

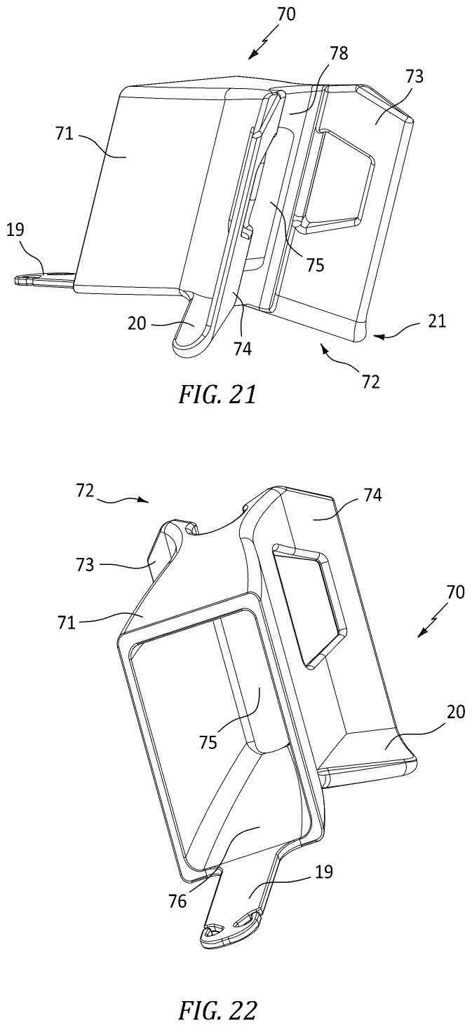

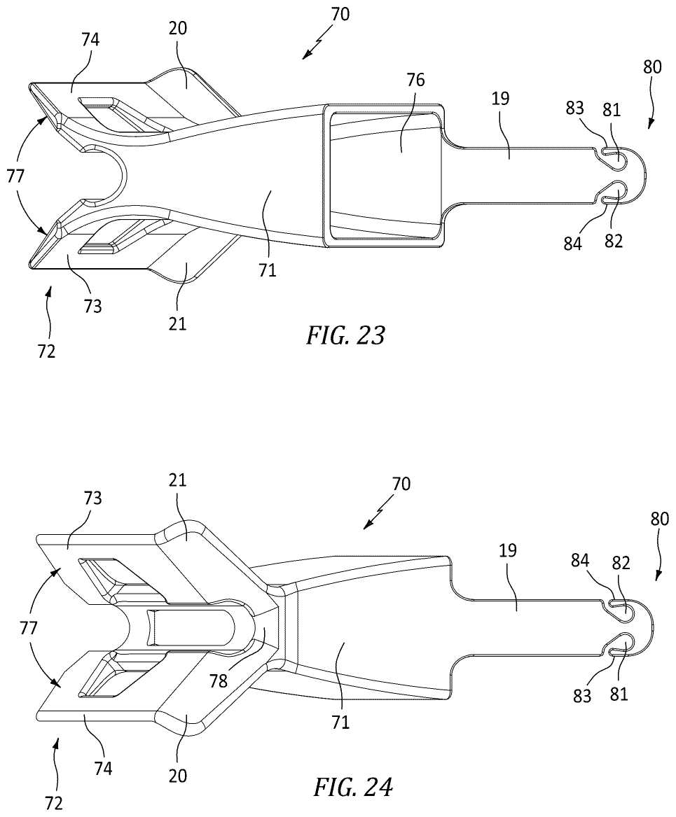

Referring next to FIGS. 20-24, there is shown an alternative implementation of outside corner guide 70 which includes hollow main body 71 and outside guide 72 positioned on a front end of the main body. Similar to outside corner guide 10 (FIGS. 2-6), outside guide 72 is comprised of left arm 73, right arm 74 and blade slot 75. In this particular implementation, blade slot 75 is ovoid slot and is positioned in a middle portion scalloped region 78. Left arm 73 and right arm 74 are planar surfaces projecting in forwardly direction from scalloped region 78 and away from main body 71 and are positioned at a predetermined outside angle 77 (FIG. 23, 24) to each other wherein the vertex of outside angle 77 is positioned proximate or outside of ovoid blade slot 75. In the implementation shown, outside angle 77 is approximately 90 degrees and is configured to accommodate an outside corner of a cardboard container as will be disclosed in more detail herein after. It should be appreciated by those skilled in the art that the combination of blade slot 75 and scalloped region 78 that a portion of cutting end 3 (FIG. 1) will protrude into the scallop area and during use, the cutting end of the utility knife can be biased against the outside corner 53 (FIG. 14). It should be further appreciated by those skilled in the art that the size and positioning of ovoid blade slot 75 may have some advantages over strike plate 38 and blade slot 15 of outside corner guide 12 (FIGS. 2-6). Those advantages include the ability to clear debris from the cutting process without collecting in the blade slot area. In some implementations, outside angle 77 can include any angle that approximates the angle of the container to be cut and further includes angles slightly less and slightly mor than the angle of the container to be cut. Main body 71 is comprised of a hollow member forming a knife cavity 76 with blade slot 75 positioned on a front portion thereof. It should be further appreciated by those skilled in the art that main body 71 can be comprised of a conformable material such as rubber or a rigid plastic or other suitable material to provide a snug (or interference) fit around the cutting end of a utility knife (cutting end 3 in FIG. 1). Outside guide 72 can be comprised of the same material as main body 71 or a different material or can be comprised of a combination of materials. For example, left arm 73 and right arm 74 can be comprised of a material having a low coefficient of friction configured to slide along the surface of a cardboard container during use. It should be noted that outside corner guide 70 further includes attachment tang 19 positioned on a bottom portion for attachment to a utility knife. It should be appreciated that other implementations can include an optional attachment tang that can similarly be removably attached to the utility knife.

Referring to FIGS. 23, 24 in particular, there is shown a detail of an implementation of attachment tang 19. In this implementation, attachment tang 19 includes a locking tab 80 position on a distal end of outside corner guide 70 that includes a left attachment loop 81 and a right attachment loop 82. Left attachment loop 81 includes left pinch arm 83 and a right attachment loop 82 includes right pinch arm 84. In this implementation, an elastic band, such as a rubber band (not shown), can be slidably engaged within left attachment loop 81 by passing it through the gap formed between left pinch arm 83 and attachment tang 19 and threaded through key chain hole 6 (FIG. 1) and engaged within right attachment loop 82 by passing it through the gap formed between right pinch arm 84 and the attachment tang to hold outside corner guide 70 removably attached to the utility knife 1 (FIG. 1). It should be appreciated by those skilled in the art that right pinch arm 83 and left pinch arm 84 is configured to releasably retain the rubber band within left attachment loop 81 and a right attachment loop 82.

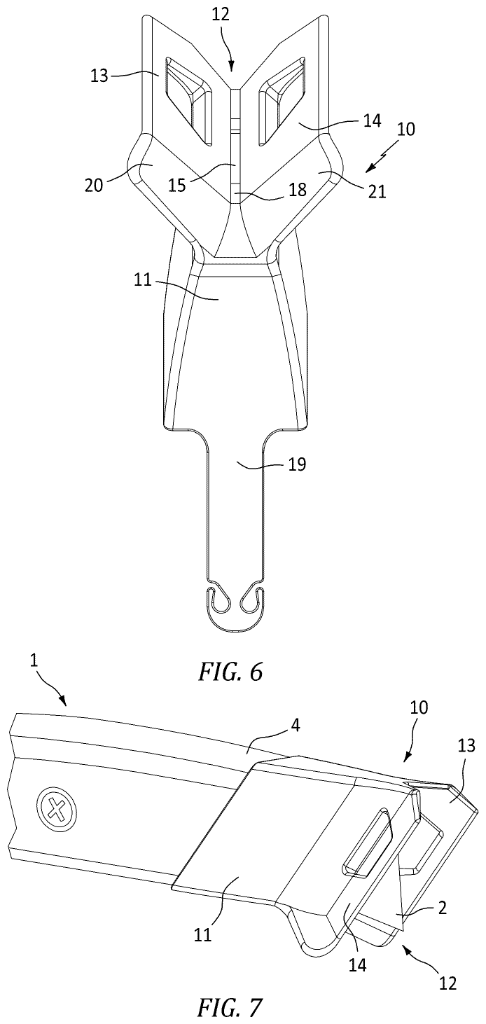

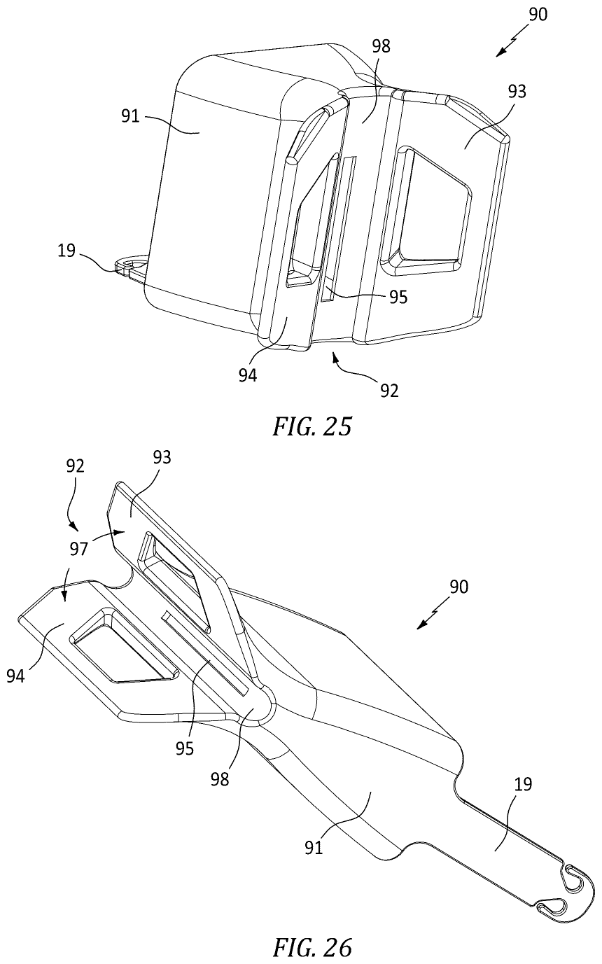

Referring now to FIGS. 25, 26, there is shown an alternative implementation of outside corner guide 80 which includes hollow main body 81 and outside guide 82 positioned on a front end of the main body. Similar to outside corner guide 12 (FIGS. 20-24), outside guide 82 is comprised of left arm 83, right arm 84 and blade slot 85. In this particular implementation, blade slot 85 is a slot similar to blade slot 15 of outside corner guide 12 (FIGS. 2-6) and is positioned in the middle of scalloped region 88. Left arm 83 and right arm 84 are planar surfaces projecting forwardly from scalloped region 88 and away from main body 81 and are positioned at a predetermined outside angle 87 (FIG. 23, 24) to each other wherein the vertex of outside angle 87 is positioned proximate or outside of blade slot 85. In this implementation, left arm 83 and right arm 84 are planar and do not include curved tips (20, 21, FIG. 6) as an alternative. In the implementation shown, outside angle 87 is approximately 90 degrees and is configured to accommodate an outside corner of a cardboard container as will be disclosed in more detail herein after. It should be further appreciated by those skilled in the art that the size and positioning of scalloped region 88 may have some advantages over blade slot 15 of outside corner guide 12 (FIGS. 2-6). Those advantages include the ability to clear debris from the cutting process without collecting in the blade slot area. In some implementations, outside angle 87 can include any angle that approximates the angle of the container to be cut and further includes angles slightly less and slightly mor than the angle of the container to be cut. Main body 81 is comprised of a hollow member forming a knife cavity 86 with blade slot 85 positioned on a front portion thereof. It should be further appreciated by those skilled in the art that main body 81 can be comprised of a conformable material such as rubber, rigid plastic or other suitable material to provide a snug (or interference) fit around the cutting end of a utility knife (cutting end 3 in FIG. 1). Outside guide 82 can be comprised of the same material as main body 81 or a different material or can be comprised of a combination of materials. For example, left arm 83 and right arm 84 can be comprised of a material having a low coefficient of friction configured to slide along the surface of a cardboard container during use. It should be noted that outside corner guide 80 further includes attachment tang 19 positioned on a bottom portion for attachment to a utility knife.

The foregoing disclosure provides illustration and description but is not intended to be exhaustive or to limit the implementations to the precise form disclosed. Modifications may be made in light of the above disclosure or may be acquired from practice of the implementations. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A knife blade guide comprising:
a hollow main body;
a corner guide positioned on a front end of the hollow main body comprising:
a right guide arm projecting from the front end;
a left guide arm projecting from the front end;
a blade slot positioned between the right guide arm and the left guide arm; and
wherein the right guide arm and the left guide arm are positioned at a predetermined angle apart from each other.

2. The knife blade guide of claim 1 further wherein the hollow main body is configured to fit over a housing of a utility knife at a cutting end of the utility knife.

3. The knife blade guide of claim 2 wherein the blade slot is configured to accommodate a cutting blade of the utility knife.

4. The knife blade guide of claim 3 wherein the blade slot is configured to be positioned proximate a corner of a container and the right guide arm and the left guide arm are configured to be positioned against a respective side of the container.

5. The knife blade guide of claim 4 wherein the corner guide is an outside corner guide comprising:
the right guide arm and the left guide arm project in a forwardly direction from the hollow main body; and
the blade slot is any of a rectangular slot and an ovoid slot.

6. The knife blade guide of claim 5 wherein the outside corner guide is configured to be placed on an outside portion of the corner of the container and the right guide arm and the left guide arm are configured to be positioned against an outside surface of the respective side of the container.

7. The knife blade guide of claim 6 wherein the blade slot is configured to be positioned proximate an outside surface of the corner of the container.

8. The knife blade guide of claim 7 wherein the outside corner guide is configured to guide the utility knife along the outside surface of the corner of the container and the cutting blade is configured to cut the corner of the container.

9. The knife blade guide of claim 8 wherein the predetermined angle is an outside guide angle and is chosen to match an outside angle of the corner of the container.

10. The knife blade guide of claim 9 wherein the outside guide angle comprises an approximate 90 degree angle between the right guide arm and the left guide arm.

11. The knife blade guide of claim 4 wherein the right guide arm comprises a planar portion and a curved tip positioned on a bottom portion of the planar portion and the left guide arm comprises a planar portion and a curved tip positioned on a bottom portion of the planar portion.

12. The knife blade guide of claim 4 further comprising a strike plate positioned between the right guide arm and the left guide arm wherein the blade slot is positioned within the strike plate.

13. The knife blade guide of claim 4 further comprising a scalloped region positioned between the right guide arm and the left guide arm wherein the blade slot is positioned within the scalloped region.

14. The knife blade guide of claim 4 wherein the corner guide is an inside corner guide comprising:
the right guide arm and the left guide arm project in a rearwardly direction from the blade slot.

15. The knife blade guide of claim 14 wherein the inside corner guide is configured to be placed on an inside portion of the corner of the container and the right guide arm and the left guide arm are configured to be positioned against an inside surface of the respective side of the container.

16. The knife blade guide of claim 15 wherein the blade slot is configured to be placed proximate an inside surface of the corner of the container.

17. The knife blade guide of claim 16 wherein the inside corner guide is configured to guide the utility knife along the inside surface of the corner of the container and the cutting blade is configured to cut the corner of the container.

18. The knife blade guide of claim 17 wherein the predetermined angle is an inside guide angle and is chosen to match an inside angle of the corner of the container.

19. The knife blade guide of claim 18 wherein the inside guide angle comprises an approximate 270 degree angle between the right guide arm and the left guide arm.

20. The knife blade guide of claim 1 further wherein the hollow main body comprises a housing of a utility knife at a cutting end.

21. The knife blade guide of claim 20 wherein the blade slot is configured to accommodate a cutting blade of the utility knife.

22. The knife blade guide of claim 21 wherein the blade slot is configured to be positioned proximate a corner of a container and the right guide arm and the left guide arm are configured to be positioned against a respective side of the container.

23. The knife blade guide of claim 22 wherein the corner guide is an outside corner guide comprising:
the right guide arm and the left guide arm project in a forwardly direction from the blade slot; and
the blade slot is any of a rectangular slot and an ovoid slot.

24. The knife blade guide of claim 23 wherein the outside corner guide is configured to be placed on an outside portion of the corner of the container and the right guide arm and the left guide arm are configured to be positioned against an outside surface of the respective side of the container.

25. The knife blade guide of claim 24 wherein the blade slot is configured to be positioned proximate an outside surface of the corner of the container.

26. The knife blade guide of claim 25 wherein the outside corner guide is configured to guide the utility knife along the outside surface of the corner of the container and the cutting blade is configured to cut the corner of the container.

27. The knife blade guide of claim 26 wherein the predetermined angle is an outside guide angle and is chosen to match an outside angle of the corner of the container.

28. The knife blade guide of claim 27 wherein the outside guide angle comprises an approximate 90 degree angle between the right guide arm and the left guide arm.

29. The knife blade guide of claim 22 wherein the corner guide is an inside corner guide comprising:
the right guide arm and the left guide arm project in a rearwardly direction from the blade slot; and
a vertex of the predetermined angle is positioned at a point beyond the blade slot.

30. The knife blade guide of claim 29 wherein the inside corner guide is configured to be placed on an inside portion of the corner of the container and the right guide arm and the left guide arm are configured to be positioned against an inside surface of the respective side of the container.

31. The knife blade guide of claim 30 wherein the blade slot is configured to be positioned proximate an inside surface of the corner of the container.

32. The knife blade guide of claim 31 wherein the inside corner guide is configured to guide the utility knife along the inside surface of the corner of the container and the cutting blade is configured to cut the corner of the container.

33. The knife blade guide of claim 32 wherein the predetermined angle is an inside guide angle and is chosen to match an inside angle of the corner of the container.

34. The knife blade guide of claim 33 wherein the inside angle comprises an approximate 270 degree angle between the right guide arm and the left guide arm.

35. The knife blade guide of claim 20 wherein the housing of the utility knife further comprises a first cutting end and a second cutting end and an inside corner guide positioned at the first cutting end and an outside corner guide positioned at the second cutting end.
